(19) United States
(12) Patent Application Publication
(10) Pub. No.: US 2016/0182606 A1
(43) Pub. Date: Jun. 23, 2016

(54) Network Based Static Font Subset Management

(71) Applicant: Monotype Imaging Inc., Woburn, MA (US)

(72) Inventors: Sampo Juhani Kaasila, Plaistow, NH (US); Vladimir Levantovsky, North Andover, MA (US); Venkat Yetrintala, Wood Dale, IL (US); Prince Dhiman, Manimajar (IN); Umesh Maheshwari, Noida (IN); Anand Vijay, Madhya Pradesh (IN)

(21) Appl. No.: 14/601,763

(22) Filed: Jan. 21, 2015

Related U.S. Application Data
(60) Provisional application No. 62/093,139, filed on Dec. 17, 2014.
(60) Provisional application No. 62/094,632, filed on Dec. 19, 2014.

(51) Int. Cl. H04L 29/08; G06Q 30/02; G06F 17/21

(52) U.S. Cl. CPC H04L 67/06; G06F 17/214; G06Q 30/0277

(57) ABSTRACT

A system includes a computing device that includes a memory configured to store instructions. The system also includes a processor to execute the instructions to perform operations that include receiving, at an imaging device, one or more files representing a network asset that is presentable on a display of the imaging device. At least one of the files includes data for presenting textual content of the network asset. Operations also include presenting on the display of the imaging device a portion of the network asset and textual content that corresponds to the portion of the network asset. Operations also include, as the portion of the network asset and corresponding textual content is being presented, executing operations at the imaging device to determine if textual content of at least one other portion of the network asset can be presented on the display using font characters residing at the imaging device.

### CLAIM OF PRIORITY

This application claims priority under 35 USC §119(e) to U.S. Patent Application Ser. No. 62/093,139, filed on Dec. 17, 2014, and U.S. Patent Application Ser. No. 62/094,632, filed on Dec. 19, 2014, the entire contents of which are hereby incorporated by reference.

### BACKGROUND

This description relates to managing font subsets and their delivery over networks to imaging devices such as printers, computing devices, etc.

In the ever-expanding connectivity provided by computer networks such as the Internet, various types of content such as text, graphics, audio, video, etc. may be included in assets (e.g., documents, presentations, websites, webpages, etc.) for presenting on computing devices. Presenting assets with such content may provide viewers with a more enjoyable viewing experience and assist with a more efficient transfer of information. However, the rapid expansion of this technology does not allow such content to always be presented seamlessly. Network bandwidth, throughput, etc. along with performance issues of user devices may impede presentations and limit a viewer's ability to view the content.

### SUMMARY

The systems and techniques described here relate to providing asset content in a timely manner and reduce delays in presenting the asset. Along with efficiently providing content, a predefined set of font information may be provided to an imaging device (e.g., at the printer, computing device, etc.) for presenting an initial portion of the asset (e.g., a first page, webpage, etc.). By providing this static set of font information, the initial content may be quickly presented to a viewer and thereby provide additional time to execute other operations (e.g., attain font information for presenting other portions of the asset) as the initial portion is being viewed. For example, one or more fonts needed for presenting a website may not be available at imaging device (e.g., a tablet computing device). To efficiently provide the needed font information, a predefined subset of font characters may initially be provided to the imaging device for presenting one portion of the website (e.g., an opening webpage). These predefined subsets (e.g., that contain most frequently used characters) may be less than completely optimal, but provide time for executing other operations as the portion is viewed. Further, by quickly presenting the initial portion (to allow other operations to be execute as the initial portion is viewed), a viewer is less likely to become frustrated while waiting for presentation of the selected asset to begin. Further, by reducing delay to initial presentation, the viewing experience can be improved along with the viewer's interest in the presented content (e.g., advertisements for products, services, etc.).

In one aspect, a computing device-implemented method includes receiving, at an imaging device, one or more files representing a network asset that is presentable on a display of the imaging device. At least one of the files includes data for presenting textual content of the network asset. The method also includes presenting on the display of the imaging device a portion of the network asset and textual content that corresponds to the portion of the network asset. The method also includes, as the portion of the network asset and corresponding textual content is being presented, executing operations at the imaging device to determine if textual content of at least one other portion of the network asset can be presented on the display using font characters residing at the imaging device.

Implementations may include one or more of the following features. At least one of the files may include data representing a set of font characters for presenting the textual content of the portion of the network asset. The set of font characters in the file may be identifiable by a software agent being executed by the imaging device. The set of font characters and each font character included in the set may be identifiable by a software agent being executed by the imaging device. Executing operations for presenting at least one other portion of the network asset may include receiving one or more other files at the imaging device. At least one of the other files may include data representing another set of font characters for presenting textual content of the other portion of the network asset. Prior to the one or more other files being received at the imaging device, the other set of font characters and each of the other font characters included in the other set may be identifiable by a software agent being executed by the imaging device. If determined that textual content of at least one other portion of the network asset cannot be presented on the display using font characters residing at the imaging device, operations may be executed to initiate a request for another set of font characters. Prior to the other set of font characters being requested, the other set of font characters and each font character included in the other set may be identifiable by a software agent being executed by the imaging device. The set of font characters for presenting textual content of the portion of the network asset may include each font character needed for presenting the textual content of the portion of the network asset. The set of font characters for presenting textual content of the portion of the network asset may include predetermined frequently used characters of the font. The set of font characters for presenting textual content of the portion of the network asset may include each font character needed for presenting the textual content of the portion of the network asset and predetermined frequently used characters of the font. The set of font characters for presenting textual content of the portion of the network asset may be represented by a static uniform resource locator. The one or more files representing the network asset may be selected for delivery based on the set of font characters present at the imaging device. The one or more files representing the network asset may be provided by a content distribution network component. The data representing a set of fonts presenting the textual content of the portion of the network asset may be provided from a font service provider. The data representing a set of fonts presenting the textual content of the portion of the network asset may be provided from an advertisement publisher. Receiving the one or more files representing a network asset may be based on operations executed at a font service provider and an advertisement publisher. The set of font characters for presenting the textual content of the portion of the network asset may be encoded using Base64 to reduce data transmission time. The software agent may include a portion for providing static functionality and dynamic functionality. A portion of the network asset may include an advertisement or other type of content. The software agent may be provided to the imaging device by a font service provider, an advertisement publisher, or the one or more files representing the network asset. Presenting the portion of the network asset on the display of the imaging device may include delaying the presentation until appropriate font characters reside at the imaging device for presenting the textual content that corresponds to the portion of the network asset. The software agent may be attainable by a static identifier for a predetermined location.

In another aspect, a system includes a computing device that includes a memory configured to store instructions. The system also includes a processor to execute the instructions to perform operations that include receiving, at an imaging device, one or more files representing a network asset that is presentable on a display of the imaging device. At least one of the files includes data for presenting textual content of the network asset. Operations also include presenting on the display of the imaging device a portion of the network asset and textual content that corresponds to the portion of the network asset. Operations also include, as the portion of the network asset and corresponding textual content is being presented, executing operations at the imaging device to determine if textual content of at least one other portion of the network asset can be presented on the display using font characters residing at the imaging device.

Implementations may include one or more of the following features. At least one of the files may include data representing a set of font characters for presenting the textual content of the portion of the network asset. The set of font characters in the file may be identifiable by a software agent being executed by the imaging device. The set of font characters and each font character included in the set may be identifiable by a software agent being executed by the imaging device. Executing operations for presenting at least one other portion of the network asset may include receiving one or more other files at the imaging device. At least one of the other files may include data representing another set of font characters for presenting textual content of the other portion of the network asset. Prior to the one or more other files being received at the imaging device, the other set of font characters and each of the other font characters included in the other set may be identifiable by a software agent being executed by the imaging device. If determined that textual content of at least one other portion of the network asset cannot be presented on the display using font characters residing at the imaging device, operations may be executed to initiate a request for another set of font characters. Prior to the other set of font characters being requested, the other set of font characters and each font character included in the other set may be identifiable by a software agent being executed by the imaging device. The set of font characters for presenting textual content of the portion of the network asset may include each font character needed for presenting the textual content of the portion of the network asset. The set of font characters for presenting textual content of the portion of the network asset may include predetermined frequently used characters of the font. The set of font characters for presenting textual content of the portion of the network asset may include each font character needed for presenting the textual content of the portion of the network asset and predetermined frequently used characters of the font. The set of font characters for presenting textual content of the portion of the network asset may be represented by a static uniform resource locator. The one or more files representing the network asset may be selected for delivery based on the set of font characters present at the imaging device. The one or more files representing the network asset may be provided by a content distribution network component. The data representing a set of fonts presenting the textual content of the portion of the network asset may be provided from a font service provider. The data representing a set of fonts presenting the textual content of the portion of the network asset may be provided from an advertisement publisher. Receiving the one or more files representing a network asset may be based on operations executed at a font service provider and an advertisement publisher. The set of font characters for presenting the textual content of the portion of the network asset may be encoded using Base64 to reduce data transmission time. The software agent may include a portion for providing static functionality and dynamic functionality. A portion of the network asset may include an advertisement or other type of content. The software agent may be provided to the imaging device by a font service provider, an advertisement publisher, or the one or more files representing the network asset. Presenting the portion of the network asset on the display of the imaging device may include delaying the presentation until appropriate font characters reside at the imaging device for presenting the textual content that corresponds to the portion of the network asset. The software agent may be attainable by a static identifier for a predetermined location.

In another aspect, one or more computer readable media storing instructions that are executable by a processing device, and upon such execution cause the processing device to perform operations that include receiving, at an imaging device, one or more files representing a network asset that is presentable on a display of the imaging device. At least one of the files includes data for presenting textual content of the network asset. Operations also include presenting on the display of the imaging device a portion of the network asset and textual content that corresponds to the portion of the network asset. Operations also include, as the portion of the network asset and corresponding textual content is being presented, executing operations at the imaging device to determine if textual content of at least one other portion of the network asset can be presented on the display using font characters residing at the imaging device.

Implementations may include one or more of the following features. At least one of the files may include data representing a set of font characters for presenting the textual content of the portion of the network asset. The set of font characters in the file may be identifiable by a software agent being executed by the imaging device. The set of font characters and each font character included in the set may be identifiable by a software agent being executed by the imaging device. Executing operations for presenting at least one other portion of the network asset may include receiving one or more other files at the imaging device. At least one of the other files may include data representing another set of font characters for presenting textual content of the other portion of the network asset. Prior to the one or more other files being received at the imaging device, the other set of font characters and each of the other font characters included in the other set may be identifiable by a software agent being executed by the imaging device. If determined that textual content of at least one other portion of the network asset cannot be presented on the display using font characters residing at the imaging device, operations may be executed to initiate a request for another set of font characters. Prior to the other set of font characters being requested, the other set of font characters and each font character included in the other set may be identifiable by a software agent being executed by the imaging device. The set of font characters for presenting textual content of the portion of the network asset may include each font character needed for presenting the textual content of the portion of the network asset. The set of font characters for presenting textual content of the portion of the network asset may include predetermined frequently used characters of the font. The set of font characters for presenting textual content of the portion of the network asset may include each font character needed for presenting the textual content of the portion of the network asset and predetermined frequently used characters of the font. The set of font characters for presenting textual content of the portion of the network asset may be represented by a static uniform resource locator. The one or more files representing the network asset may be selected for delivery based on the set of font characters present at the imaging device. The one or more files representing the network asset may be provided by a content distribution network component. The data representing a set of fonts presenting the textual content of the portion of the network asset may be provided from a font service provider. The data representing a set of fonts presenting the textual content of the portion of the network asset may be provided from an advertisement publisher. Receiving the one or more files representing a network asset may be based on operations executed at a font service provider and an advertisement publisher. The set of font characters for presenting the textual content of the portion of the network asset may be encoded using Base64 to reduce data transmission time. The software agent may include a portion for providing static functionality and dynamic functionality. A portion of the network asset may include an advertisement or other type of content. The software agent may be provided to the imaging device by a font service provider, an advertisement publisher, or the one or more files representing the network asset. Presenting the portion of the network asset on the display of the imaging device may include delaying the presentation until appropriate font characters reside at the imaging device for presenting the textual content that corresponds to the portion of the network asset. The software agent may be attainable by a static identifier for a predetermined location.

These and other aspects and features and various combinations of them may be expressed as methods, apparatus, systems, means for performing functions, program products, and in other ways.

Other features and advantages will be apparent from the description and the claims.

### DESCRIPTION OF DRAWINGS

FIG. 1 illustrates exemplary content that may be provided to imaging devices for presentation.

FIG. 2 is a block diagram of an Internet based computer network.

FIG. 3 illustrates files provided to an imaging device for font subset management.

FIG. 4 illustrates font subset delivery to an imaging device.

FIG. 5 illustrates network components for font subset management.

FIG. 6 presents example font subsets.

FIG. 7 is an example flow chart of operations for font subset management.

FIG. 8 illustrates an example of a computing device and a mobile computing device that can be used to implement the techniques described here.

### DETAILED DESCRIPTION

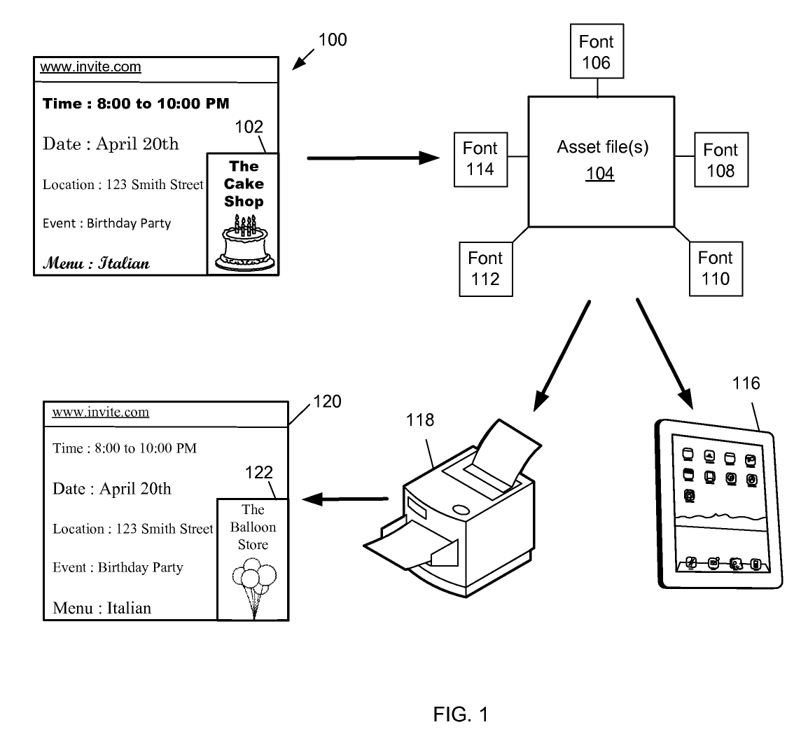

Referring to FIG. 1, various types of assets may be produced for presentation. For example, assets such as documents, presentations, etc. may be produced locally or remotely by a computing device (e.g., a computer system, smart telephone, etc.), or, assets such as a network asset (e.g., a webpage 100) may also be remotely produced and accessible through the Internet (or another type of computer network). Such network assets like the webpage 100 may be accessed by providing appropriate identifying information (e.g., a uniform resource locator (URL)) to a web browser or other type of asset presenter. For example, once accessed, the web asset may be packaged and sent from a corresponding asset provider to an imaging device (e.g., a computing device, printer, etc.) for presentation. In the illustrated example, the content of the webpage 100 includes a birthday party invitation that includes text and graphics, and may be accessed from a particular URL (i.e., www.invite.com). Additionally, a portion of the webpage 100 includes an advertisement 102 whose content is associated with the subject of the invitation (e.g., a cake shop that markets birthday cakes). Often multiple advertisements may be sequentially presented in the same real estate on a webpage (e.g., to quickly appear and grab the viewer's attention). To provide an eye-catching webpage, the invitation and advertisements use multiple fonts that provide different typefaces, each of which can be considered as providing stylistic characters or glyphs. In general, for presenting such text and similar graphics, various types of font families (e.g., Times New Roman, Arial, etc.) may be used that typically include a set of fonts, e.g., regular, italic, bold, bold italic, etc. Each font generally includes a set of individual character shapes called glyphs and the glyphs generally share various design features (e.g., geometry, stroke thickness, serifs, size, etc.) associated with the font. One or more techniques may be utilized for representing such fonts; for example, outline-based representations may be adopted in which lines and curves are used to define the borders of glyphs. Such fonts may be scalable for a variety of sizes (e.g., for being presented by various imaging devices) and may be represented in one or more formats. For example, scalable outline fonts may be represented in a format that includes data structures capable of supporting a variety of typographic visual symbols of many languages.

Once produced, assets (e.g., electronic documents, presentations, etc.) may be provided to imaging devices for presentation. For example, one or more electronic documents (e.g., an MS-Word document, MS-PowerPoint presentation, MS-Excel file, portable document format (PDF) file, etc.) may be provided (e.g., directly sent from a local computing device, sent remotely using one or more protocols such as electronic mail protocols, etc.) to an imaging device (e.g., a printer, computing device, etc.). Produced assets may also be accessed from remote. For example, once accessed, one or more content providers may use techniques to provide the content of a network asset (e.g., the webpage 100) to an imaging device. In this arrangement, the webpage 100 may be represented in one or more asset files 104 that may employ different techniques. For example, the asset file(s) 104 may include a hypertext markup language (HTML) file that includes instructions for presenting the asset and a cascading style sheet (CSS) file that provides presentation semantics for the asset being presented by the HTML file. Standards such as the World Wide Web Consortium (W3C) standards for HTML, CSS, XML and other standards may be implemented so the webpage 100 can be properly rendered on various types of imaging devices capable of displaying electronic content (e.g. computer systems, tablet computing device, smart phones, personal digital assistants (PDAs), handheld computers, set-top boxes, heads up display (HUD), Internet appliances, etc.). Displaying such electronic content may take other forms, for example, imaging devices such as printers may produce hard copy presentations of the webpage 100.

The one or more asset file(s) 104 may reference one or more fonts used to render text of the webpage. For illustration, five different fonts are used in the webpage 100 to provide information associated with the invitation (e.g., time, date, location, event description, and menu). As such, the asset file(s) 104 calls out each font such that the recipient imaging device is aware which font corresponds to each portion of textual information (e.g., present the date in a “Times New Roman” font). Upon receiving and executing the instructions included in the asset file(s) 104, the recipient imaging device may locally retrieve the fonts needed to present the text. However, instances may occur when the font information provided with asset file(s) 104 is not sufficient for presenting each character. For example, font characters used in the asset may not be locally present at the imaging device. A considerable numbers of imaging devices (e.g., printers, computer systems, etc.) may be unable to locally store all the characters of each font that could potentially be needed to render the webpage. Limited resources (e.g., memory) and the constant creation of new font types can restrict an imaging device from being ready to display text in any and all fonts. Fonts associated with different languages amplify the issue in that many imaging devices are unable to store all font types. Languages such as Chinese, Japanese, Korean, etc. use alphabets of characters that may number in the tens of thousands (e.g., over 10,000 characters) and call for 1 MB to 20 MB of memory to store the characters of a single language. Such memory needs are impractical, especially for imaging devices with less robust onboard memory (e.g., printers, cellular telephones, etc.). From some devices, font substitution techniques may be employed for presenting content in such situations. For example, a device may substitute the nearest equivalent font (based upon appearance) for a font included in an asset but not residing at the device.

Following the logic of having every potential font type locally stored at an imaging device, storing complete character sets for even a few fonts may be inefficient if only a few characters are needed from a set (e.g., to present a particular webpage or other type of asset). Referring to the illustrated example, a relatively small number of “Times New Roman” font characters are needed to present the event date (e.g., “A”, “p”, “r”, “i”, “1”, “2”, “0”, “t” and “h”) and transmitting and storing the complete font character set may be considered an unwise use of memory of an imaging device, certainly if a complete character set is stored for each possible user language (e.g., English, Chinese, Japanese, etc.). Further, the time needed for transferring fonts along with bandwidth consumption may also provide a concern. For example, transferring complete character sets of fonts associated with languages such as Chinese, Japanese and Korean may need considerable bandwidth and transfer time.

Transmission of such data, including large character sets may also hinder the viewing experience of an asset. For example, waiting for such data to be received at the recipient imaging device may noticeably delay the presentation of the asset and frustrate the end viewer. As illustrated in the figure, to present the webpage 100 with an imaging device, six complete font character sets 106, 108, 110, 112, 114 are provided along with the asset file(s) 104. Along with a significant number of font characters slowing transmission of the asset (e.g., the delivery of each character set may need to be negotiated by the recipient and source), processing each of the font sets can further delay the presentation of the asset. For example, the recipient imaging device may identify and select needed font characters for presenting each of the multiple advertisements in a cyclically manner over a period of time on the same portion of the webpage. As such, additional delay may be incurred, which can further frustrate an end viewer waiting to view the webpage while portions of the asset (e.g., later presented advertisements) are being prepared but that are not initially presented.

In some situations font sets may not be provided with asset files and the device may use locally residing fonts to present the asset. For example, provided the asset file(s) 104, a printer 118 may substitute for any font identified in the asset file(s) that is missing from the printer. By substituting each missing font with the closest matching font, the printer may attempt to create an output. However, while similar information may be presented, the overall look and style of the asset may be sacrificed. In this particular example, the printer 118 produces a printout 120 of the asset that includes local font characters (stored on the printer) substituted for the originally selected fonts in the webpage 100. In this instance the printout used that same substitute font (Times New Roman) for each of line of text presented in the printout 120. As such, the printout 120 is absent the overall look and style of the original web page 100.

Along with effecting static portions of the asset (e.g., the non-changing portions such as the presented time, date, etc. of the event), missing fonts can affect portions of an asset that change over time. For example, one or more of the advertisements being cyclically presented may not appear are originally designed. As illustrated, the initial advertisement 102 inserted into the lower right portion of the webpage 100 may be cycled out (after a predetermined period of time) and another advertisement 122 may be presented in the same real estate when the printout 120 is created. With the font characters for this other advertisement 122 missing from the printer 118, the substitute font may similarly be utilized, thereby potentially producing a less attractive advertisement.

One or more techniques may be implemented to provide appropriate font information, which may be missing from an imaging device. For example, rather the sending data that represents each character of a particular font (along with an asset), a portion of font characters (referred to as a subset) may be sent to reduce the time needed to present an initial portion of the asset (e.g., an opening webpage of a multi-page website). Employing such font subsets can also improve data transmission since less font data is being delivered. As such, loading time of advertisements and other content may be reduced, thereby potentially improving the effectiveness of the advertisement (e.g., dynamic changing advertisements, advertisements present on multi-page websites, etc.). Referring to the illustrated example, each of the font character sets 104-112 may be replaced with significantly smaller font subsets that can be provided with the asset file(s) 104 or relatively soon after receipt of the file. Further, selection of the characters included in the respective font subsets may speed up presentation time and improve the viewing experience.

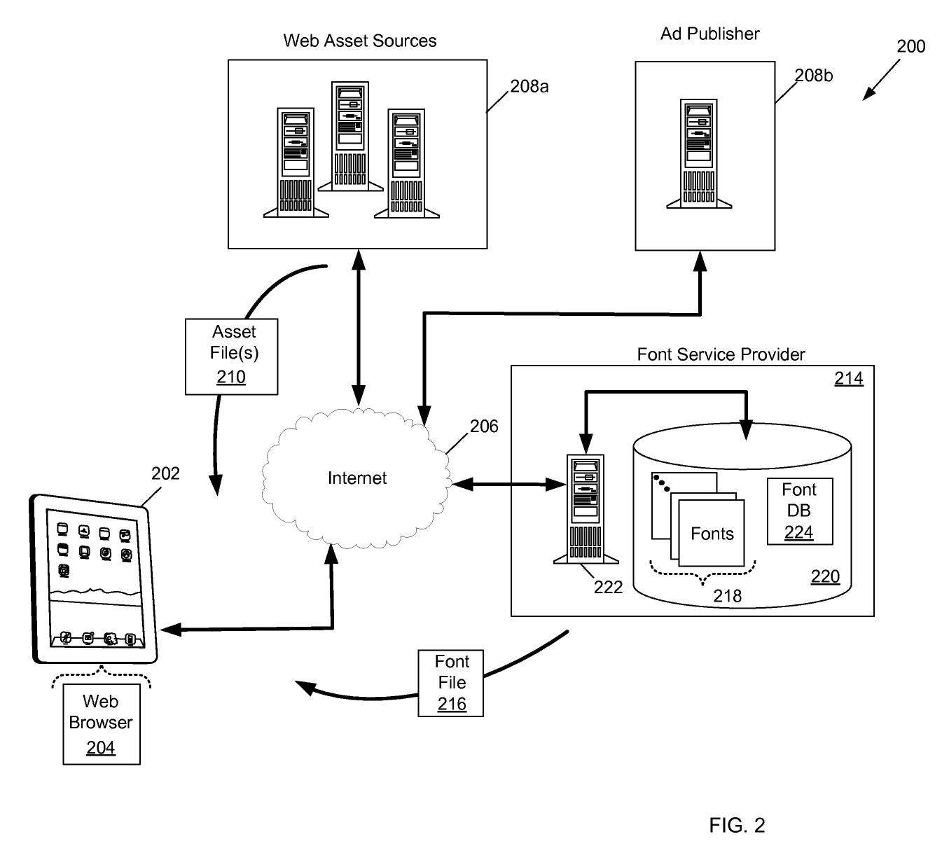

Referring to FIG. 2, a computing environment 200 includes a tablet computing device 202 that a user may interact with to identify a target web asset (e.g., a website) to be presented by the tablet's display. For example, a web browser 204 or similar software application may be executed by the tablet 202 for the user to target one or more webpages. Upon being identified, operations of the web browser 204 may include requesting, via the Internet 206, content from one or more web asset sources 208 a,b,c for the target website (e.g., that can include multiple pages). As illustrated, in this particular example a webpage is requested from webpage source 208a and corresponding asset file(s) 210 (e.g., an HTML file, a CSS file, etc.) are sent from the source through the Internet 206 to the tablet device 202. In one arrangement, the web asset file(s) 210 include a hypertext markup language (HTML) file that includes instructions for presenting the asset and a cascading style sheet (CSS) file that provides presentation semantics for the asset being provided by the HTML file. In some arrangements, content, files, etc. may be provided from multiple sources, for example, webpages for a website may be provided by the web asset source 208a while one or more advertisements may be provided by an advertisement publisher 208b (referred to as an “Ad publisher”). In such a multi-source arrangement, various types of advertisements may be provided for presentation with the asset. For example, static advertisements may be provided or advertisements that dynamically change over periods of time may be provided by the Ad publisher 208b.

In this arrangement, the computing environment 200 also includes a font service provider 214 that provides font information (e.g., font subsets) to the tablet computing device 202 for presenting the target asset. Predefined font subsets, newly created fonts subsets, etc. may be provided by the font service provider 214 to address the needs of the tablet device 202. To illustrate, a font file 216 is used in this example to provide the appropriate font information to the imaging device (e.g., the tablet 202), however other techniques may be employed. Along with providing font information such as font subsets, the font service provider 214 may execute other operations. For example, along with font subset production, the font service provider 214 may be capable of determining if complete font character sets should be provided to the requesting computing device. For example, predefined rules may be used by the font service provider 214 to determine whether a font subset should be sent. One such rule may indicate that font character sets associated with particular languages (e.g., Chinese) should have subsets created due to the large size of complete Chinese character set. While static rules may be used for such determinations, such subset determinations may also be executed in a dynamic manner.

To provide the appropriate font information (e.g., subsets), the font service provider 214 typically needs access to one or more libraries of fonts that may be stored local or remote to the font service provider. As represented in the figure, a library of fonts 218 is shown being stored in a storage device 220 (e.g., one or more hard drives, CD-ROMs, etc.) on site. Being accessible by a server 222, the font library 218 may be used to produce appropriate font information (e.g., complete font sets, font subsets, etc.). Illustrated as being stored in a single storage device 220, the font service provider 214 may use numerous storage techniques and devices to retain a collection of accessible font sets (e.g., for different font styles, languages, etc.). The font service provider 214 may also access font information (e.g., font sets) at separate locations for collecting the needed information. For example, upon identifying fonts, font characters, font subsets, etc., the server 222 may be used to collect needed information from one or more sources external to the font service provider 214 (e.g., via the Internet 206).

Along with producing font information (e.g., complete font sets, font subsets, etc.) and providing it to imaging devices (e.g., tablet 202), the font service provider 214 may provide other functionality. For example, fonts and font subsets associated with particular assets (e.g., webpages and websites) may be tracked for future requests. In one scenario, one or more font subsets (e.g., included in font file 216) may be created for presenting a particular webpage. The association between the font subsets and the webpage may be identified (e.g., by the server 222) and stored for later retrieval. As such, the subsets needed to present the webpage in the future (e.g., on another computing device) can be quickly identified and provided to the requesting computing device. In one arrangement, a font database 224 is stored at the font service provider 214 (e.g., on the storage device 220) and includes records that represent various associations, e.g., between webpages and font subsets (and fonts).

In some arrangements, functionality (or portions) of the font service provider 214 may be provided by one or more other components. For example, providing font information (e.g., font subsets) may be executed by the advertisement publisher 208b or other system components. Along with managing advertisements, which may include dynamically changing advertisement content, the advertisement publisher 208b can provide font information by employing one or more techniques such as sending font files that contain the font character subset or subsets needed to present an advertisement at an imaging device (e.g., the tablet computing device 202). Similarly, other components such as the web asset sources 208a may execute font service provider functionality such as font subset creation, delivery, storage, management, etc.

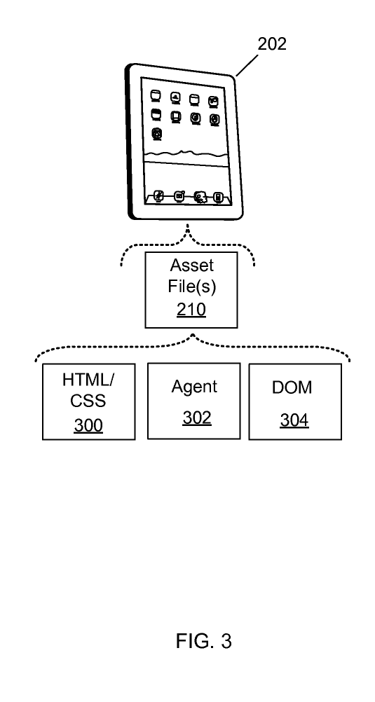

Referring to FIG. 3, one or more techniques may be employed to determine the particular font subsets for delivery. In many instances, a single subset or a few subsets can support the textual needs of an asset such as a webpage of a website. As such, characters may be preselected and font subsets predefined in some instances. Determining the characters to include in these subsets can be based on a variety of selection techniques. For example, characters that have historically used and frequently appear in such assets (e.g., webpages) can be included in a subset to support the presenting of other assets such as similar assets (e.g., other webpages). For western scripts, like English which is based on the Latin alphabet, frequently used characters for these fonts may be cataloged (e.g., at a font service provider 214) and initially provided to support the presentation of an asset. Similar to using characters that appear frequently, other types of selection criteria may be employed; for example, the exact characters being used by an asset (e.g., webpage, advertisement, etc.) can be inserted into a font subset. As such, each needed font character will be delivered to the imaging device to present the asset. In some arrangements, these exact characters correspond to the characters initially used by an asset. For example, the characters used by the first webpage of a website may be included in a first font subset (provided to the tablet 202) and the characters used in other webpages (e.g., the second webpage of the website) may be included in one or more subsequent font subsets. In some arrangements, combinations of the exact character to be used and frequently used font characters may be included in an initial font subset provided to an imaging device. Typically, such font subsets are created, managed, sent from, etc. a font service provider (such as the font service provider 214 shown in FIG. 2). However, other sources (e.g., asset sources, Ad publishers, etc.) may similarly manage and transmit such subsets to recipient imaging devices.

One or more techniques may be employed for delivering such font subsets. For example, an initial font subset (e.g., containing frequently used characters, exactly needed characters, a combination likely occurring and exactly needed characters, etc.) may be provided to the imaging device (e.g., the tablet 202). As illustrated for this example, the asset file(s) 210 include an HTML file and a CSS file (labeled HTML/CSS 300) that provide access to an initial font subset. For example, a URL can be included in the HTML/CSS 300 for accessing the initial font subset. Additionally, executable instructions may be provided by the asset file(s) 210 (or by another file or files) to determine font character needs of the imaging device to present the asset along with other functionality (represented in the asset file(s) 210). For example, a software agent 302 may be included that is capable of identifying the individual fonts, font characters, etc. needed by the asset and to determine if one or more of these fonts, font characters, etc. is missing from the tablet computing device 202 (e.g., not residing in memory, a local storage device, etc.). In the illustrated example, the software agent 302 can be realized with JavaScript instructions that when executed check a document object model (DOM) 304 of the asset to be presented. The DOM 304 can be considered a tree structure representation of the elements of the asset represented by the asset file(s) 210. By checking the DOM tree 304 as the asset is being prepared for presentation, the agent 302 can determine if information such as font character codes used by the asset are missing. If font information is determined to be missing, one or operations may be executed by the software agent 302 alone or in concert with the tablet computing device 202 (and potentially other computing devices), for example, to gather information for identifying the missing font(s), etc. For example, the software agent 302 may initiate a request being sent to attain the appropriate font subset(s) beyond an initial font subset that is provided for presenting the asset.

Along with including instructions for determining missing font information, the software agent also includes data (or is provided access to data) that identifies the font subsets that can be potentially provided (e.g., from the font service provider 214) to the tablet device 202. Along with being aware of font subsets that can be provided, each character included in the potential subsets can be identified in the data that is attainable be the software agent 302. As such, the software agent 302 is aware of the font characters included in the initial font subset (e.g., attainable from the HTML/CSS 300) and also font characters included in other font subsets that can be delivered as subsequent font subsets. With this information, the software agent 302 can efficiently identify the particular font subset or subsets needed to present the asset. In one arrangement, upon determining that character codes are not present in the initial font subset, the software agent can determine if any of these missing character codes can be provided by one of the other predefined font subsets to which the software agent is aware. Once identified, one or more techniques may be used to attain such subsequent font subsets. For example, if one or more such other subsets are identified, the software agent 302 can execute operations to insert the information into the DOM tree 304 such that the appropriate font subset are attained for providing the needed font characters. Identifying missing font characters may also occur for the initial asset portion to be presented (e.g., the first webpage of the website). For example, the software agent 302 may determine that appropriate character coverage is not provided by the font characters residing at the imaging device (e.g., one or more needed font characters are missing from the initial font subset, local storage of the imaging device, etc.). In response to determining the missing font characters, the software agent 302 may initiate sending a request (e.g., to the font service provider) for one or more subsets to appropriately support each needed font character. In some arrangements, the software agent 302 may identify the missing font characters and request a subset be dynamically produced. The software agent could identify the particular subset(s) for attaining needed character support in some arrangements. As the needed font characters are being attained, the imaging device may execute operations in preparation of receiving the font character data. For example, presentation of initial portion of the asset may be delayed until the needed font characters are residing at the imaging device. As such, the asset may not be displayed on the imaging device until the request initiated by the software agent 302 has been satisfied (e.g., the font service provider sends the missing font characters).

Such a software agent can be considered a software module that is executable in a substantially autonomous manner. For example, upon being provided to tablet computing device 202, the software agent 302 may operate without considerable user interaction. By operating in a somewhat flexible manner, the software agent can adaptively identify fonts, font characters, character codes, etc. needed for asset presentation and compare this font information with the font data of the predefined font subsets that can be potentially provided (e.g., by the font service provider 214). Other functionality such as manipulating DOM trees may also be executed by the software agent in a similar manner. Also, similar to investigating the DOM tree 304 for making such determinations, the software agent 302 may access (e.g., scan) other portions of the asset file(s) 210 (e.g., a HTML file, a CSS file, etc.) in a somewhat persistent manner to identify needed font information. The software agent 302 may execute in a substantially continuous manner to perform its operations. One or more sources may provide software agents, for example, an asset source (e.g., the web asset source 208a) such as one or more servers for a website may provide an agent, access to an agent, etc. A font service provider may also be a software agent source; for example, an agent can be provided upon receiving a request at a font service provider. Other types of sources may provide agents; for example, an advertisement publisher (e.g., the Ad publisher 208b shown in FIG. 2) may provide an agent to assist with presenting advertisements at an imaging device. In some arrangements, a non-changing (e.g., static) identifier may be used to access the software agent at the corresponding source. For example, a static uniform resource locator (URL) may be assigned to a software agent located at a source (e.g., the font service provider). For the situation in which multiple sources provide the software agent, a static URL may be used at each source for providing access to a corresponding portion of the software agent. For one architecture, the software agent may be provided by a static URL at a source (e.g., a font service provider, Ad publisher, etc.) and data fragments associated with the static URL (e.g., hash parameters) are used to attain data for the software agent. The software agent (e.g., implemented in JavaScript) can be used for attaining access to other files, data, etc. (e.g., for downloading other JavaScript files). Such agents may operate in concert with functionality executed at imaging device. For example, web browser operations can work with agent operations executed from JavaScript code included one or more files of a network asset (e.g., HTML/CSS file(s)) provided by a font service provider. To improve viewing experience (and hopefully reduce viewer frustration), some operations of the software agent 302 may be executed in parallel with presenting one portion of an asset. For example, as an initial font subset (that contains the exact font characters needed to present an opening webpage of a website) is used to present that portion of the asset, the software agent can identify one or more other font subsets as being needed to present other portions (e.g., subsequent webpages of the website) can be attained in the background. Having knowledge of the font subsets, the characters included in the subsets, etc., the software agent 302 can attain any other subset(s) (e.g., from the font service provider 214) that is needed beyond the characters provided by the initial subset. As such, one or more subsequent subsets can be attained in parallel while one portion (e.g., the opening webpage of a website) is being presented, thereby collecting additional characters to present the asset but reduce the frustration experienced by a viewer caused by delay in presenting any portion of an asset.

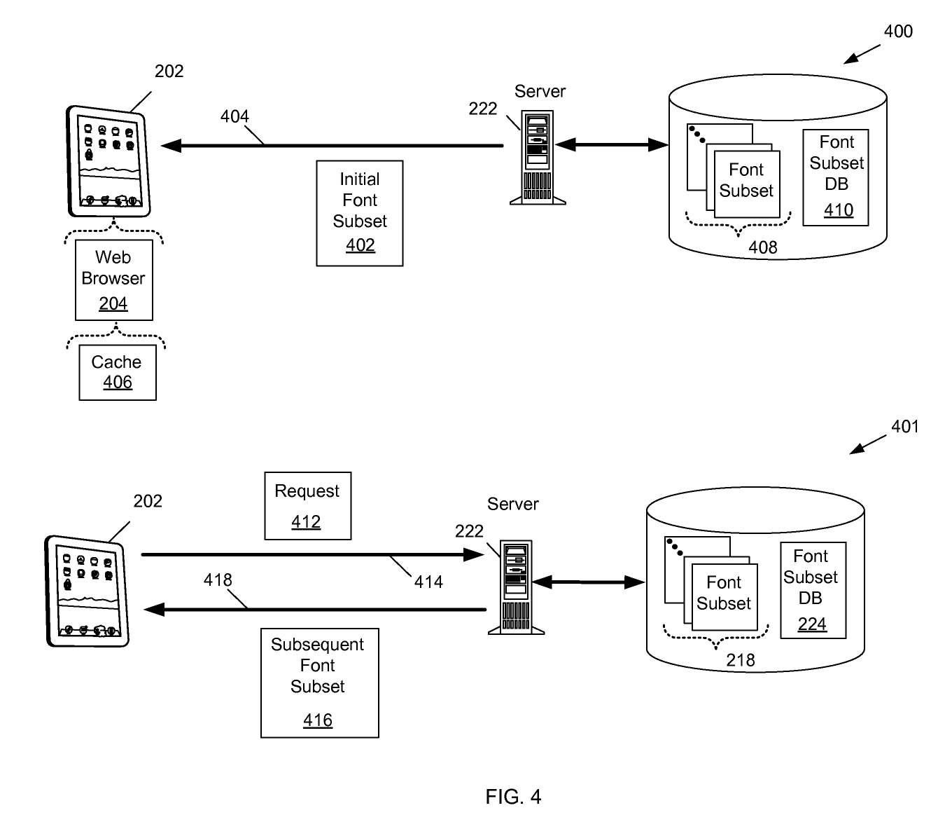

Referring to FIG. 4, a sequence of operations graphically illustrate the tablet computing device 202 performing operations in parallel for presenting an asset. With reference to operations associated with graphic 400, upon selecting an asset for presentation (via the web browser 204) an initial font subset 402 is provided to tablet computing device 202 from the server 222 located at the font service provider 214 (as illustrated with arrow 404). Once received, the initial font subset 402 is stored on a cache 406 of the web browser 204, thereby allowing relatively quick access to the initial font subset (and eliminating the need to again download the subset in the near future). To allow efficient presentation of an initial portion of the asset (e.g., the first webpage of a target website, an initial advertisement, etc.), content of the initial font subset may include character data representing the exact characters needed to present this initial portion. In this arrangement, the contents of this initial font subset 402 have been previously prepared and the subset stored in a subset collection 408 (at the font service provider 214) for access as needed. For managing the subsets, a font subset database 410 is employed in this example such that the appropriate subset is retrieved from the collection 408. Used as the initial font subset 402, the font subset database 410 may identify the subset as being associated with an initial portion (e.g., an opening webpage) of the asset. While less efficient, in some arrangements, the initial font subset may be dynamically produced to provide the appropriate font characters for presenting an initial portion of the asset. For example, rather than having the font subset of the exact characters predefined, a software agent (e.g., provided with the asset file(s)) may investigate the DOM tree of the asset, identify the needed font characters, and initiate a request that the subset by produced and delivered (from the server 222 of the font service provider 214).

In some arrangements, this predefined font subset (that can be considered static) is provided with the data that represents the asset (or a portion of the asset). For example, the initial font subset 402 can be sent with an HTML file and CSS file of the asset of interest (e.g., the HTML/CSS file 300). And if the initial font subset includes the exact font characters needed to present an initial portion of the asset, the software agent does not need to check for characters missing to present this initial portion. Rather the software agent can focus on checking on the font characters needed to present other portions of the asset while the initial portion is being presented.

As mentioned, the initial subset can include the exact font characters needed by an initial portion of the asset (e.g., opening webpage, initial advertisement, etc.). The software agent provided with the asset file(s) is aware of the content of this initial subset (e.g., can identify the subset and included characters by accessing data, etc.). In some arrangements, other character sets may be included in the initial font subset. For example, font characters identified as frequently used characters (or likely to occur characters) can be included, and in some instances these frequently used characters may be provided in union with the exact font characters needed by the initial asset portion. As such, font characters are initially provided to present the initial asset portion without delay and also potentially provide font characters for subsequent asset portions to be presented. One or more techniques may be used to identify such frequently used characters; for example, historical usage data of particular characters (e.g., the character “e”) may be used for defining membership for the initial subset. Frequency of character use for similar assets (e.g., characters used in particular types of websites, advertisements, etc.) may also be used to define membership. Other types of selection criteria, factors, etc. may also be utilized to play a role in defining font character subsets.

With the initial font subset 402 residing in the cache 406 and being used to present an initial portion of the asset, the software agent can determine if appropriate character information resides at the tablet 202 for presenting other portions of the asset. For example, the DOM tree of the asset can be investigated by the software agent to determine if needed font characters are missing. If additional characters are needed, the software agent can execute operations to have the needed font information attained. For example, the DOM tree of the asset can be manipulated by the software agent such that one or more appropriate font subsets can be attained when needed. Such DOM tree manipulations can be performed by one or more techniques such as using jQuery operations. Again, since the software agent is aware of and can identify font subsets that can be called, and their characters, the agent can identify the subsequent subsets without significant assistance. In some instances, as illustrated in graphic 401, the software agent can initiate the sending of a request 412 to the server 222 of the font service provider 214 (as illustrated with the arrow 414). Being aware of the identity of the font subsets 218 stored at the font service provider, the request from the software agent can include data that identifies the one or more subsets that include font characters needed for presenting the other asset portions. Provided the request, a subsequent font subset 416 is delivered to the tablet computing device 202 (as illustrated by the arrow 418).

One or more types of events may trigger the sending of the request 412 (or other operation being executed) for one or more subsequent font subsets. For example, different user interactions with the imaging device (e.g., the tablet computing device 202) may initiate the collection of subsequent font subsets for other portions of an asset. In one scenario, an initial font subset can be provided for text residing in the upper portion of a webpage that is to be presented on the tablet device. A user interaction (e.g., operating a scroll control, moving another portion of the presented page, etc.) can initiate a request being sent for the other portion of the page that is yet to be presented on the device's display. Other types of interactions may also be trigger events; for example, user placement a pointing device (e.g., hovering a graphical cursor) over a location on the display (e.g., the border of the display) can initiate a request being sent. Changes in presented content can also trigger a request being sent for one or more subsequent font subsets. For example, a software agent (e.g., the software agent 302) or other type of process can monitor content being presented for potential changes. In applications such as presenting advertisements, switching among different advertisements (being presented in one portion of the display) allows the user to see many advertisements in a rapid manner (and hopefully catch the viewer's eye). Advertisement changes can also occur due to user interactions (e.g., clicking with a pointing device upon a presented advertisement). In such situations, a process such as an event handler (e.g., incorporated into the software agent, a stand alone software application, etc.) can detect a change advertisement presentation (e.g., detect a “flash ad”, user interaction, etc.) and operate with the software agent (e.g., notify the software agent) that a subsequent font subset is needed and initiate appropriate operations (e.g., send a request). In one arrangement, an event handler can monitor elements associated with the HTML of the presented asset to detect potential content changes with any of the elements.

The characters included in such subsequent font subsets may be based on a variety of factors. For example, one or more complete font character sets may be sent in the subsequent font subset 416. With font characters already loaded and being used by the device, the complete font subsets can be loaded in the background and thereby not significantly affect the presentation of the initial portion of the asset. The subsequently sent font subset(s) may be created such that each is missing any characters previously sent (e.g., provided in the initial font subset 402) thereby reducing transmission redundancy.

Rather sending complete font sets, other types of subsequent font subsets may be sent. For example, the request 412 may identify a subset that includes the next most frequently used set of font characters, which is different from any previously sent font subset of frequently occurring characters. Upon receiving such a font subset (of next most frequently used font characters), the software agent may investigate the DOM tree of the asset to determine if any additional font characters used by the asset are still not present on that device. If determined characters are still missing, another request can be sent from the tablet computing device 202 to the font service provider 214. As such, font subsets may be provided in an incremental basis in the background while earlier provided subsets are utilized for presenting an asset. Examples of such incremental font subsetting techniques are described in U.S. patent application Ser. No. 12/457,792, entitled “Font Data Streaming”, filed 22 Jun. 2009, which is incorporated by reference in its entirety, and can be utilized.

In some instances, the subsequent font subset 416 can contain the exact font characters needed to present another portion of the asset, given that the font characters provided by the initial font subset already reside at the device (and should not be resent). Such a scenario can occur when the font characters needed for the subsequent portion of the asset are known. For example, a webpage may initially present one advertisement that needs one subset of font characters. After a period of time (e.g., a few seconds), another advertisement may be presented on the webpage in place of the first advertisement. This second advertisement may use some of the initially provided font characters, but may also need additional characters. Since the second advertisement is known (e.g., identified by the advertisement publisher prior to being sent to the tablet device), the subsequent font subset can be determined and can be prepared to include only the font characters needed to present the second advertisement (given that the initial font subset already resides at the device). As such, subsequent font subsets may include only the exact font characters needed to present other asset portions. In some situations, such font subsets that only include the exact font characters may be produced as needed. For example, the request 412 may identify the characters needed (e.g., to present the second advertisement) and a subset may be produced by the server 222 of the fonts service provider 214 at that time.

In still another example, the subsequent font subset can include a combination of font character sets. For example, the subset can include the exact characters missing from the initial font subset and the most frequently occurring characters given that the initial font subset is already residing at the tablet computing device. In one demonstrative scenario, the initial font subset 402 may include the exact characters for presenting a first webpage of a website. Provided to the device 202 and while being used to present the first webpage, the request 412 can be sent to the server 222 and may identify two subsets: a subset that includes font characters (not present in the initial font subset) for presenting a second page of the website and also the most frequently occurring font characters (that are also not present in the initial font subset). By including this combination of two character sets, the subsequent font subset 416 not only provides the exact characters needed to present the second webpage but also incrementally supplements the font characters present at the device for efficiently presenting other webpages by speculating that font characters frequently used in the past will be used again on still more web pages.

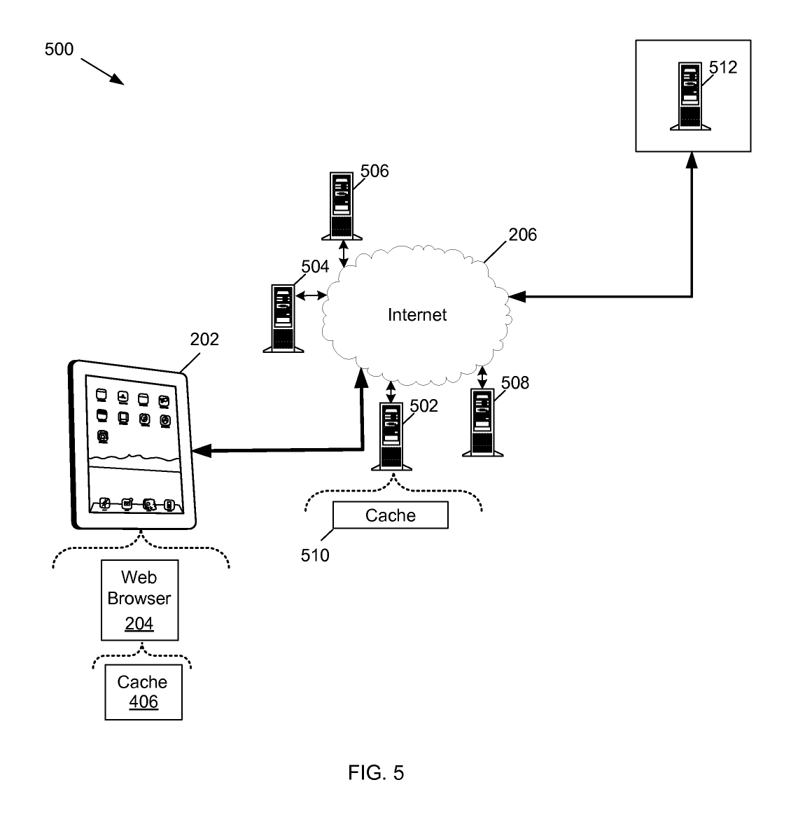

Referring to FIG. 5, in addition to user devices executing operations to manage font subsets (e.g., identify a predefined subset as an initial font subset, identify subsequent font subsets, etc.), other techniques may be used for employed to efficiently provide such font subsets to the devices. For example, various network architectures, such as network environment 500, may be utilized for optimizing font subset use. As illustrated, various types of storage devices may strategically store font subsets to aid access and use. Previously mentioned, one or more caches (e.g., the cache 406 of the web browser 204) located at the user device (e.g., the tablet computing device 202) may store font subsets for relatively quick access for operations such as presenting portions of an asset (e.g., webpages of a website). Some architectures can employ networking techniques such as content delivery networking (CDN) that uses high performance schemes such that stored subsets are highly available. In general a CDN can be a large distribution of servers deployed in multiple data centers connected to one or more networks (e.g., the Internet 206). The servers are included in nodes (of the CDN) that are typically distributed across multiple locations. By employing such nodes, the CDN can reduce load times of the font subsets along with increasing the global availability of the font subsets along with other types of content. The number of nodes included in a CDN may vary along with the number of servers present at each node; from relatively small networks to global networks that can include thousands of nodes. As illustrated in the figure, a collection of CDN servers 502, 504, 506, 508 are distributed at various locations and connected to the Internet 206. Each CDN server includes one or more caches (graphically illustrated by a cache 510 included in the CDN server 502). By storing various font subsets in the caches of these CDN servers, user devices such as the tablet computing device 202 can relatively quickly gain access and be delivered one or more font subsets such as an initial font subset. Along with the font subsets other types of content such as data representing various advertisements may be stored by the CDN servers for quick access.

Other networking architectures may also be used for distributing, storing, etc. font subsets and other types of content. For example, less efficient and remotely located servers can be utilized, as illustrated with a remote server 512. Compared to CDN nodes, such devices can be considered slower to provide data to other devices and locations (e.g., the tablet computing device 220). Such remote servers may be components of cloud computing architectures and use less optimal networking schemes for font distribution. For example, entities such as font service providers, advertisement publishers, etc. may use such servers for a variety of functionality and thereby they may not be tuned for data distribution such as CDN nodes. Such remote servers may not be typically used for storing predefined font subsets or other content (e.g., previously produced advertisements). Rather, these devices may be primarily use for other tasks such as producing content. For example, if a needed subset has not been previously produced, the remote server 512 (which may be located at a font service providers) may be used to dynamically produce the subset. Once produced the subset can be sent to the requesting device (e.g., the tablet computing device 202). Stored in the cache 406 of the web browser 204, this subset could be quickly accessible. Additionally, the newly produced website could also be stored at one or more caches of the server 502, 504, 506, 508 that reside at the CDN nodes. As such, multiple types of access points are provided by the network environment 500 that provide different levels of content availability. Along with storing data, other functionality may be provided by the network environment 500; for example, operations may be executed by one or more of the components (e.g., the CDN nodes, the remote server 512, etc.) to check for duplicate font subsets being stored at multiple locations within the environment (and remove them). Operations may also include updating the software agents (e.g., JavaScript) present that the imaging devices. With font subsets being changed, new subsets being created, deleted, etc., updates are needed for the software agents to maintain their currency in regards to the predefined font subsets, font characters included in the subsets, etc.

Similar to architecture design, other techniques may be employed to assist transmission of the font subsets. For example, different data transmission schemes from may be utilized; for example, initial font subsets may utilize one form while subsequent subsets may use different forms (or in some instances equivalent forms). Often initial font subsets are identified in the asset file(s) received by the requesting imaging device. For example, an initial font subset can be embedded in a CSS file or an HTML file provided to the tablet computing device 202. To embed the font subset, one or more techniques may be applied; for example, encoding schemes such as Base64 may be used that represents binary data in an ASCII format. Embedding such binary data using Base64 may increase the size of the file (e.g., the size of the CSS file may increase due to the embedded binary data). However, embedding such data may not significantly increase the size of the file. Additionally, reducing the number of files sent can reduce data transmission time. Typically, a negotiation occurs between the sender and recipient of each file to be sent over a network. Often the time needed to perform this negotiation can slow the data transmission process much more than the delay caused by increasing the size of the file. As such, rather than introducing more delay due to negotiating the transmission of more files, less delay is introduced by negotiating for the transmission of a smaller number of files (even if the file size has increased). But situations may occur when font subset transmission can be improved by sending more files. Such files could include binary files, text files (e.g., containing Base64 representations), etc. Data conversion techniques may also be employed to convert the data from one form to another, e.g., convert binary data into a text representation. Additionally, based on the network architecture employed, such subset files can be provided from one or multiple sources; for example, while initial font subset files may be provided by a font service provider, an advertisement publisher, etc., such files may be sent from one source (e.g., a font service provider) to another source (e.g., an advertisement publisher) that converts the file prior to providing the font subset to an end-user device (e.g., the tablet computing device 202). By employing different transmission schemes, architectures, etc., transmission of initial and subsequent font subsets may be optimized for delivery.

Other format techniques may also be exploited to further optimize data transmission and efficiency. For example, non-changing (e.g., static) identifiers may be used for accessing font subsets. In one arrangement, static uniform resource locators (URL) may be assigned to each font subset (stored within a CDN, a font service provider, etc.). The non-changing aspect of the URL can provide various advantages; for example, the constant nature of the identifier reduces the probability an incorrect identifier being used or an incorrect font subset being provided. Compared to a dynamic URL, which typically changes over time based upon one or more parameters, a static URL maintains its validity and can typically be used over significant period of time while still providing the originally assigned font subset (or other content).

Other techniques may be employed to assist the transmission of font subsets to imaging devices. For example, environment conditions (e.g., of the connected network), data transmission characteristics (e.g., channel capacity, etc.), etc. may be monitored (e.g., by the imaging device, a remotely located server, etc.) and used for data transmission as described in U.S. patent application Ser. No. 13/629,593, entitled “Network Based Font Management for Imaging Devices”, which is incorporated by reference in its entirety. Various file types, structures, etc. may also be utilized to optimize data transmission; for example, binary data files, text based files, etc. may be used for transmitting font subjects. In some situations binary files can be transmitted and the contained data converted into text after being received at the imaging device. In other arrangements, files may be transmitted in other forms (e.g., text files, JavaScript files, etc.) can be used for font subset transmission.

As mentioned above, by using suboptimal font subsets (e.g., a subset of frequently used font characters rather than a subset of characters as exactly needed), subsets may be prepared and stored (e.g., at browser cache of the imaging device, quickly accessible caches of a CDN, etc.) prior to being needed by the imaging device. As such hundred or even thousands of font subsets can be produced and stored (for quick access) prior to being used. Further, by including font characters most likely to be used, the probability is increased that each needed character will be present in the initial subset provided to the imaging device. In some arrangements, after the initial subset is provided, needed font characters not present in the initial subset can be attained in a dynamic manner. For example, one or more requests can be sent by the imaging device to be provided one or more subsets to attain the remaining characters. In some situations, the software agent can identify each additional font subset needed. In other situations, the request may identify the needed font characters and a subset may be dynamically produced (e.g., at the font service provider) and sent to the imaging device in need. Further, either technique may be used separate, in concert, with other techniques, etc., in an incremental manner to attain font characters as needed with minimal redundancy.

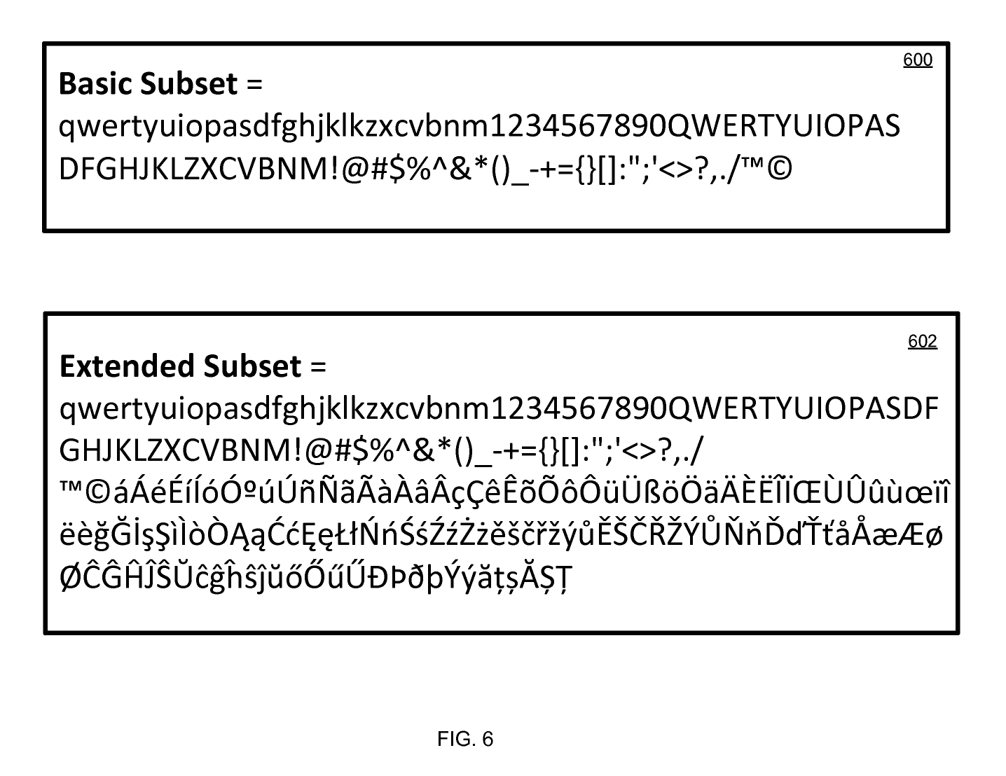

Referring to FIG. 6, an initially sent font subset may include various characters that are most likely to be used in an asset. In some arrangements, the initially sent font subset may be relatively basic in regards to the characters included. As illustrated in the figure, a basic subset 600 includes a relatively minor number of characters and symbols that represent the most frequently used for a font. More extensive subsets may also be initially sent; for example, an extended font subset 602 may be sent that includes the characters of the basic subset along with additional characters that are not as frequently used in assets. One or more techniques may be employed to determine which initial font subset should be sent. For example, the software agent (e.g., JavaScript code) provided to the imaging device can review the asset to be presented (e.g., investigate the DOM tree of the asset) to determine the characters initially used by the asset (e.g., on the first web page of a website). Being aware of the subsets that could potentially be sent, the software agent can identify the appropriate basic font subset or a more extended font subset for delivery. Various mechanisms may assist the software agent in making such a determination; for example, one or more flags may be set (e.g., a language flag) based on the textual content of the asset to be presented and the software agent may identify the appropriate font subsets based on the conditions of the flags. For example, a relatively basic and static font subset may be initially sent, and then an extended font subset may be sent that is also static in nature. Such basic and extended font subsets may depend upon other conditions, for example, the language (e.g., English, Chinese, etc.) may also factor in determining which characters should be included in the basic subset and which in the extended subset.

Other techniques may also be employed that assist with asset presentation by sending relatively sub-optimal font character subsets. For example, after an initial subset is provided, one or more characters may be found to be missing. Such scenarios may occur with dynamic advertisements when switching from one advertisement (for which all needed font characters are present) to another advertisement (for which one or a few font characters may not be present). Being aware of the potential font subsets that can be requested and downloaded, the software agent at the imaging device can attempt to determine the smallest subset that includes the missing character (or the few missing characters). In some situations, the software agent may determine that a subset of an entirely different font is optimal (e.g., a relatively small subset that contains the missing character in the correct font has not been previously prepared and an identified subset of another font that contains the character and can be quickly attained from a CDN node). In such a case, the subset of the different font may be attained. The software agent may also look to the locally stored fonts and font subsets. For example, if a character of a font can not be found in an initial (or perhaps in a subsequent) font subset, a different font stored in the system of the imaging device (e.g., a fallback font in the system memory of the tablet computing device) may be accessed to attain the missing character or characters. As such, the software agent may determine it optimal to switch to a different font to attain a limited number of missing characters and adjust the DOM tree of the asset for using this different font for particular characters. Use of locally resident fonts may also be exploited to present various portions of an asset. For example, aware of a fallback font residing at the imaging device, an asset may be adjusted (e.g., its DOM tree manipulated) to use the local font, e.g., in place of one or more other fonts originally contemplated for presenting the asset. Font similarly or other conditions may drive the font switch, which may also improve presentation efficiency.

Similar to selecting appropriate font subsets, different executable instructions may be selected based upon the environment of the imaging device. For example, different JavaScript may be provided based upon the browser being executed by an imaging device. As such, depending upon the browser being used, different software agents may be provided. In one arrangement, multi-segment JavaScript can be produced for operating with multiple types of browsers (e.g., a segment for each browser). Once the browser type is known (e.g., via communications with the imaging device executing the browser), an appropriate segment of the JavaScript may be identified and the remaining segments of the JavaScript removed. By selectively providing just the portion of JavaScript needed by the browser, memory needs can be reduced and data transmission increased.

One or more other techniques may also be used to improve performance. For example, the functionality of the software agent may be distributed among other processes to optimize performance. In one arrangement, a portion of JavaScript may be incorporated into a browser (or each type of browser) for performing operations such as monitoring asset portions (e.g., pages of a website), determining if appropriate fonts are present, etc. This portion can be considered as core functionality that is rather static, and can be provided once and executed as many times as needed. More dynamically changing portions of the functionality (e.g., time dependent, asset content dependent, etc.) can be provided (e.g., downloaded) as needed. For example, similar to fonts themselves, the number of initial static font subsets may grow over time along with their distribution over networks (e.g., being stored in CDN nodes for different advertisements, etc.). As such, to manage such dynamically changing information, one or more files (e.g., JavaScript files) can be sent to imaging devices to provide appropriate updates regarding the font subsets and related information. To utilize such core portions and dynamic portions, techniques described above may be employed; for example, static identifiers (e.g., a static URL) may be used for accessing either of these portions, data used by either portion, etc.

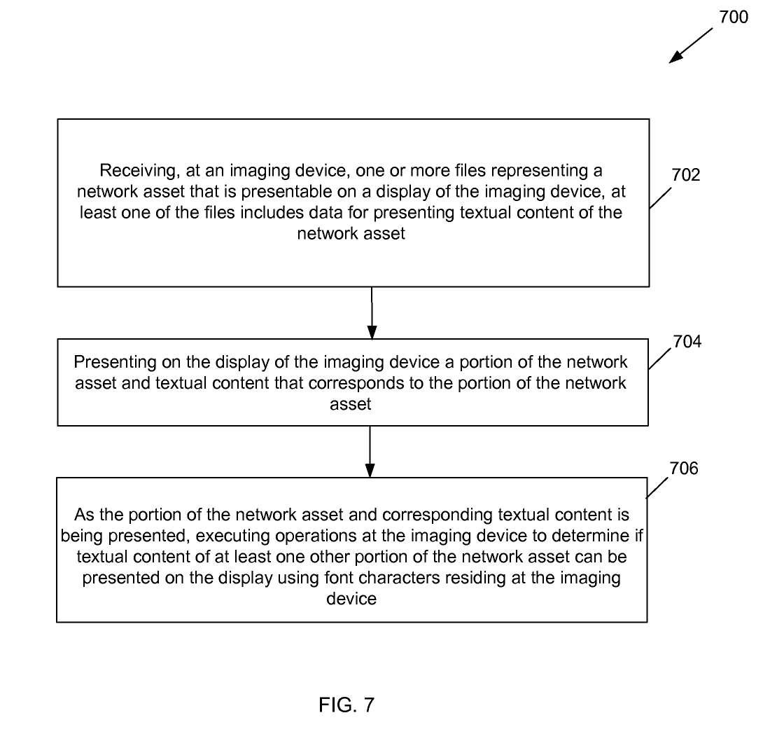

Referring to FIG. 7, a flowchart 700 represents operations of processes (e.g., the agent 302 shown in FIG. 3) being executed by an imaging device. Such operations are typically executed by a single computing device (e.g., the tablet computing device 202), however, operations may be executed by multiple computing devices. Along with being executed at a single site (e.g., the location of an imaging device), operation execution may be distributed among two or more locations.

Operations being executed may include receiving 702, at an imaging device, one or more files representing a network asset that is presentable on a display of the imaging device. At least one of the files includes data for presenting textual content of the network asset. For example, a tablet computing device may receive data that represents an asset such as a network asset (e.g., a website, webpage, etc.) from one or more sources. Operations also include presenting 704 on the display of the imaging device a portion of the network asset and textual content that corresponds to the portion of the network asset. For example, textual content of an initial portion of a website (e.g., opening page of a website) can be presented. Operations also include, as the portion of the network asset and corresponding textual content is being presented, executing 706 operations at the imaging device to determine if textual content of at least one other portion of the network asset can be presented on the display using font characters residing at the imaging device. For example, as the initial portion of the asset is being presented, a software agent executed by the imaging device can determine in parallel if any additional font subsets are needed for presenting subsequent portions (other webpages) of the website. Along with be capable of initiating a response for any needed font subsets, the software agent can identify the needed subsets.

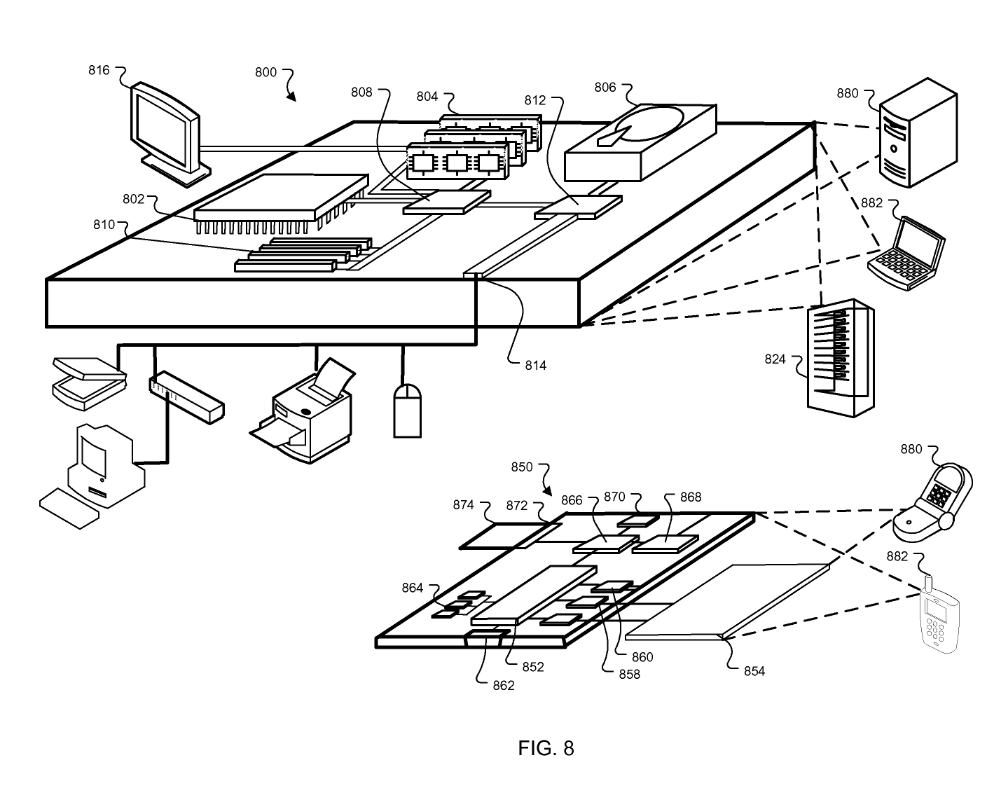

FIG. 8 shows an example of example computer device 800 and example mobile computer device 850, which can be used to implement the techniques described herein. For example, a portion or all of the operations of the software agent 302 (shown in FIG. 3) may be executed by the computer device 800 and/or the mobile computer device 850. Computing device 800 is intended to represent various forms of digital computers, including, e.g., laptops, desktops, workstations, personal digital assistants, servers, blade servers, mainframes, and other appropriate computers. Computing device 850 is intended to represent various forms of mobile devices, including, e.g., personal digital assistants, tablet computing devices, cellular telephones, smartphones, and other similar computing devices. The components shown here, their connections and relationships, and their functions, are meant to be examples only, and are not meant to limit implementations of the techniques described and/or claimed in this document.

Computing device 800 includes processor 802, memory 804, storage device 806, high-speed interface 808 connecting to memory 804 and high-speed expansion ports 810, and low speed interface 812 connecting to low speed bus 814 and storage device 806. Each of components 802, 804, 806, 808, 810, and 812, are interconnected using various busses, and can be mounted on a common motherboard or in other manners as appropriate. Processor 802 can process instructions for execution within computing device 800, including instructions stored in memory 804 or on storage device 806 to display graphical data for a GUI on an external input/output device, including, e.g., display 816 coupled to high speed interface 808. In other implementations, multiple processors and/or multiple buses can be used, as appropriate, along with multiple memories and types of memory. Also, multiple computing devices 800 can be connected, with each device providing portions of the necessary operations (e.g., as a server bank, a group of blade servers, or a multi-processor system).

Memory 804 stores data within computing device 800. In one implementation, memory 1304 is a volatile memory unit or units. In another implementation, memory 804 is a non-volatile memory unit or units. Memory 804 also can be another form of computer-readable medium, including, e.g., a magnetic or optical disk. Memory 804 may be non-transitory.

Storage device 806 is capable of providing mass storage for computing device 800. In one implementation, storage device 806 can be or contain a computer-readable medium, including, e.g., a floppy disk device, a hard disk device, an optical disk device, or a tape device, a flash memory or other similar solid state memory device, or an array of devices, including devices in a storage area network or other configurations. A computer program product can be tangibly embodied in a data carrier. The computer program product also can contain instructions that, when executed, perform one or more methods, including, e.g., those described above. The data carrier is a computer- or machine-readable medium, including, e.g., memory 804, storage device 806, memory on processor 802, and the like.

High-speed controller 808 manages bandwidth-intensive operations for computing device 800, while low speed controller 812 manages lower bandwidth-intensive operations. Such allocation of functions is an example only. In one implementation, high-speed controller 808 is coupled to memory 804, display 816 (e.g., through a graphics processor or accelerator), and to high-speed expansion ports 810, which can accept various expansion cards (not shown). In the implementation, low-speed controller 812 is coupled to storage device 806 and low-speed expansion port 814. The low-speed expansion port, which can include various communication ports (e.g., USB, Bluetooth®, Ethernet, wireless Ethernet), can be coupled to one or more input/output devices, including, e.g., a keyboard, a pointing device, a scanner, or a networking device including, e.g., a switch or router, e.g., through a network adapter.

Computing device 800 can be implemented in a number of different forms, as shown in the figure. For example, it can be implemented as standard server 820, or multiple times in a group of such servers. It also can be implemented as part of rack server system 824. In addition or as an alternative, it can be implemented in a personal computer including, e.g., laptop computer 822. In some examples, components from computing device 800 can be combined with other components in a mobile device (not shown), including, e.g., device 850. Each of such devices can contain one or more of computing device 800, 850, and an entire system can be made up of multiple computing devices 800, 850 communicating with each other.

Computing device 850 includes processor 852, memory 864, an input/output device including, e.g., display 854, communication interface 866, and transceiver 868, among other components. Device 850 also can be provided with a storage device, including, e.g., a microdrive or other device, to provide additional storage. Each of components 850, 852, 864, 854, 866, and 868, are interconnected using various buses, and several of the components can be mounted on a common motherboard or in other manners as appropriate.

Processor 852 can execute instructions within computing device 850, including instructions stored in memory 864. The processor can be implemented as a chipset of chips that include separate and multiple analog and digital processors. The processor can provide, for example, for coordination of the other components of device 850, including, e.g., control of user interfaces, applications run by device 850, and wireless communication by device 850.

Processor 852 can communicate with a user through control interface 858 and display interface 856 coupled to display 854. Display 854 can be, for example, a TFT LCD (Thin-Film-Transistor Liquid Crystal Display) or an OLED (Organic Light Emitting Diode) display, or other appropriate display technology. Display interface 856 can comprise appropriate circuitry for driving display 854 to present graphical and other data to a user. Control interface 858 can receive commands from a user and convert them for submission to processor 852. In addition, external interface 862 can communicate with processor 842, so as to enable near area communication of device 850 with other devices. External interface 862 can provide, for example, for wired communication in some implementations, or for wireless communication in other implementations, and multiple interfaces also can be used.

Memory 864 stores data within computing device 850. Memory 864 can be implemented as one or more of a computer-readable medium or media, a volatile memory unit or units, or a non-volatile memory unit or units. Expansion memory 874 also can be provided and connected to device 850 through expansion interface 872, which can include, for example, a SIMM (Single In Line Memory Module) card interface. Such expansion memory 874 can provide extra storage space for device 850, or also can store applications or other data for device 850. Specifically, expansion memory 874 can include instructions to carry out or supplement the processes described above, and can include secure data also. Thus, for example, expansion memory 874 can be provided as a security module for device 850, and can be programmed with instructions that permit secure use of device 850. In addition, secure applications can be provided through the SIMM cards, along with additional data, including, e.g., placing identifying data on the SIMM card in a non-hackable manner.

The memory can include, for example, flash memory and/or NVRAM memory, as discussed below. In one implementation, a computer program product is tangibly embodied in a data carrier. The computer program product contains instructions that, when executed, perform one or more methods, including, e.g., those described above. The data carrier is a computer- or machine-readable medium, including, e.g., memory 864, expansion memory 874, and/or memory on processor 852, which can be received, for example, over transceiver 868 or external interface 862.

Device 850 can communicate wirelessly through communication interface 866, which can include digital signal processing circuitry where necessary. Communication interface 866 can provide for communications under various modes or protocols, including, e.g., GSM voice calls, SMS, EMS, or MMS messaging, CDMA, TDMA, PDC, WCDMA, CDMA2000, or GPRS, among others. Such communication can occur, for example, through radio-frequency transceiver 868. In addition, short-range communication can occur, including, e.g., using a Bluetooth®, WiFi, or other such transceiver (not shown). In addition, GPS (Global Positioning System) receiver module 870 can provide additional navigation- and location-related wireless data to device 850, which can be used as appropriate by applications running on device 850. Sensors and modules such as cameras, microphones, compasses, accelerators (for orientation sensing), etc. maybe included in the device.

Device 850 also can communicate audibly using audio codec 860, which can receive spoken data from a user and convert it to usable digital data. Audio codec 860 can likewise generate audible sound for a user, including, e.g., through a speaker, e.g., in a handset of device 850. Such sound can include sound from voice telephone calls, can include recorded sound (e.g., voice messages, music files, and the like) and also can include sound generated by applications operating on device 850.

Computing device 850 can be implemented in a number of different forms, as shown in the figure. For example, it can be implemented as cellular telephone 880. It also can be implemented as part of smartphone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying data to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

What is claimed is:

1. A computing device-implemented method comprising:
receiving, at an imaging device, one or more files representing a network asset that is presentable on a display of the imaging device, at least one of the files includes data for presenting textual content of the network asset;
presenting on the display of the imaging device a portion of the network asset and textual content that corresponds to the portion of the network asset; and
as the portion of the network asset and corresponding textual content is being presented, executing operations at the imaging device to determine if textual content of at least one other portion of the network asset can be presented on the display using font characters residing at the imaging device.

2. The computing device-implemented method of claim 1, wherein at least one of the files includes data representing a set of font characters for presenting the textual content of the portion of the network asset.

3. The computing device-implemented method of claim 2, wherein the set of font characters in the file are identifiable by a software agent being executed by the imaging device.

4. The computing device-implemented method of claim 1, wherein the set of font characters and each font character included in the set are identifiable by a software agent being executed by the imaging device.

5. The computing device-implemented method of claim 1, wherein executing operations for presenting at least one other portion of the network asset includes receiving one or more other files at the imaging device, wherein at least one of the other files includes data representing another set of font characters for presenting textual content of the other portion of the network asset.

6. The computing device-implemented method of claim 5, wherein prior to the one or more other files being received at the imaging device the other set of font characters and each of the other font characters included in the other set are identifiable by a software agent being executed by the imaging device.

7. The computing device-implemented method of claim 1, wherein if determined that textual content of at least one other portion of the network asset cannot be presented on the display using font characters residing at the imaging device, executing operations to initiate a request for another set of font characters, prior to the other set of font characters being requested the other set of font characters and each font character included in the other set are identifiable by a software agent being executed by the imaging device.

8. The computing device-implemented method of claim 2, wherein the set of font characters for presenting textual content of the portion of the network asset includes each font character needed for presenting the textual content of the portion of the network asset.

9. The computing device-implemented method of claim 2, wherein the set of font characters for presenting textual content of the portion of the network asset includes predetermined frequently used characters of the font.

10. The computing device-implemented method of claim 2, wherein the set of font characters for presenting textual content of the portion of the network asset includes each font character needed for presenting the textual content of the portion of the network asset and predetermined frequently used characters of the font.

11. The computing device-implemented method of claim 2, wherein the set of font characters for presenting textual content of the portion of the network asset is represented by a static uniform resource locator.

12. The computing device-implemented method of claim 1, wherein the one or more files representing the network asset are selected for delivery based on the set of font characters present at the imaging device.

13. The computing device-implemented method of claim 1, wherein the one or more files representing the network asset are provided by a content distribution network component.

14. The computing device-implemented method of claim 2, wherein the data representing a set of fonts presenting the textual content of the portion of the network asset is provided from a font service provider.

15. The computing device-implemented method of claim 2, wherein the data representing a set of fonts presenting the textual content of the portion of the network asset is provided from an advertisement publisher.

16. The computing device-implemented method of claim 1, wherein receiving the one or more files representing a network asset is based on operations executed at a font service provider and an advertisement publisher.

17. The computing device-implemented method of claim 2, wherein the set of font characters for presenting the textual content of the portion of the network asset is encoded using Base64 to reduce data transmission time.

18. The computing device-implemented method of claim 3, the software agent includes a portion for providing static functionality and dynamic functionality.

19. The computing device-implemented method of claim 1, wherein a portion of the network asset includes an advertisement.

20. The computing device-implemented method of claim 3, wherein the software agent is provided to the imaging device by a font service provider, an advertisement publisher, or the one or more files representing the network asset.

21. The computing device-implemented method of claim 1, wherein presenting the portion of the network asset on the display of the imaging device includes delaying the presentation until appropriate font characters reside at the imaging device for presenting the textual content that corresponds to the portion of the network asset.

22. A system comprising:
a computing device comprising:
a memory configured to store instructions; and
a processor to execute the instructions to perform operations comprising:
receiving, at an imaging device, one or more files representing a network asset that is presentable on a display of the imaging device, at least one of the files includes data for presenting textual content of the network asset;
presenting on the display of the imaging device a portion of the network asset and textual content that corresponds to the portion of the network asset; and
as the portion of the network asset and corresponding textual content is being presented, executing operations at the imaging device to determine if textual content of at least one other portion of the network asset can be presented on the display using font characters residing at the imaging device.

23. The system of claim 22, wherein at least one of the files includes data representing a set of font characters for presenting the textual content of the portion of the network asset.

24. The system of claim 23, wherein the set of font characters in the file are identifiable by a software agent being executed by the imaging device.

25. The system of claim 22, wherein the set of font characters and each font character included in the set are identifiable by a software agent being executed by the imaging device.

26. The system of claim 22, wherein executing operations for presenting at least one other portion of the network asset includes receiving one or more other files at the imaging device, wherein at least one of the other files includes data representing another set of font characters for presenting textual content of the other portion of the network asset.

27. The system of claim 26, wherein prior to the one or more other files being received at the imaging device the other set of font characters and each of the other font characters included in the other set are identifiable by a software agent being executed by the imaging device.

28. The system of claim 22, wherein if determined that textual content of at least one other portion of the network asset cannot be presented on the display using font characters residing at the imaging device, executing operations to initiate a request for another set of font characters, prior to the other set of font characters being requested the other set of font characters and each font character included in the other set are identifiable by a software agent being executed by the imaging device.

29. The system of claim 23, wherein the set of font characters for presenting textual content of the portion of the network asset includes each font character needed for presenting the textual content of the portion of the network asset.

30. The system of claim 23, wherein the set of font characters for presenting textual content of the portion of the network asset includes predetermined frequently used characters of the font.

31. The system of claim 23, wherein the set of font characters for presenting textual content of the portion of the network asset includes each font character needed for presenting the textual content of the portion of the network asset and predetermined frequently used characters of the font.

32. The system of claim 23, wherein the set of font characters for presenting textual content of the portion of the network asset is represented by a static uniform resource locator.

33. The system of claim 22, wherein the one or more files representing the network asset are selected for delivery based on the set of font characters present at the imaging device.

34. The system of claim 22, wherein the one or more files representing the network asset are provided by a content distribution network component.

35. The system of claim 23, wherein the data representing a set of fonts presenting the textual content of the portion of the network asset is provided from a font service provider.

36. The system of claim 23, wherein the data representing a set of fonts presenting the textual content of the portion of the network asset is provided from an advertisement publisher.

37. The system of claim 22, wherein receiving the one or more files representing a network asset is based on operations executed at a font service provider and an advertisement publisher.

38. The system of claim 23, wherein the set of font characters for presenting the textual content of the portion of the network asset is encoded using Base64 to reduce data transmission time.

39. The system of claim 24, the software agent includes a portion for providing static functionality and dynamic functionality.

40. The system of claim 22, wherein a portion of the network asset includes an advertisement.

41. The system of claim 24, wherein the software agent is provided to the imaging device by a font service provider, an advertisement publisher, or the one or more files representing the network asset.

42. The system of claim 22, wherein presenting the portion of the network asset on the display of the imaging device includes delaying the presentation until appropriate font characters reside at the imaging device for presenting the textual content that corresponds to the portion of the network asset.

43. One or more computer readable media storing instructions that are executable by a processing device, and upon such execution cause the processing device to perform operations comprising:
receiving, at an imaging device, one or more files representing a network asset that is presentable on a display of the imaging device, at least one of the files includes data for presenting textual content of the network asset;
presenting on the display of the imaging device a portion of the network asset and textual content that corresponds to the portion of the network asset; and
as the portion of the network asset and corresponding textual content is being presented, executing operations at the imaging device to determine if textual content of at least one other portion of the network asset can be presented on the display using font characters residing at the imaging device.

44. The computer readable media of claim 43, wherein at least one of the files includes data representing a set of font characters for presenting the textual content of the portion of the network asset.

45. The computer readable media of claim 44, wherein the set of font characters in the file are identifiable by a software agent being executed by the imaging device.

46. The computer readable media of claim 43, wherein the set of font characters and each font character included in the set are identifiable by a software agent being executed by the imaging device.

47. The computer readable media of claim 44, wherein executing operations for presenting at least one other portion of the network asset includes receiving one or more other files at the imaging device, wherein at least one of the other files includes data representing another set of font characters for presenting textual content of the other portion of the network asset.

48. The computer readable media of claim 47, wherein prior to the one or more other files being received at the imaging device the other set of font characters and each of the other font characters included in the other set are identifiable by a software agent being executed by the imaging device.

49. The computer readable media of claim 43, wherein if determined that textual content of at least one other portion of the network asset cannot be presented on the display using font characters residing at the imaging device, executing operations to initiate a request for another set of font characters, prior to the other set of font characters being requested the other set of font characters and each font character included in the other set are identifiable by a software agent being executed by the imaging device.

50. The computer readable media of claim 44, wherein the set of font characters for presenting textual content of the portion of the network asset includes each font character needed for presenting the textual content of the portion of the network asset.

51. The computer readable media of claim 44, wherein the set of font characters for presenting textual content of the portion of the network asset includes predetermined frequently used characters of the font.

52. The computer readable media of claim 44, wherein the set of font characters for presenting textual content of the portion of the network asset includes each font character needed for presenting the textual content of the portion of the network asset and predetermined frequently used characters of the font.

53. The computer readable media of claim 44, wherein the set of font characters for presenting textual content of the portion of the network asset is represented by a static uniform resource locator.

54. The computer readable media of claim 43, wherein the one or more files representing the network asset are selected for delivery based on the set of font characters present at the imaging device.

55. The computer readable media of claim 43, wherein the one or more files representing the network asset are provided by a content distribution network component.

56. The computer readable media of claim 44, wherein the data representing a set of fonts presenting the textual content of the portion of the network asset is provided from a font service provider.

57. The computer readable media of claim 44, wherein the data representing a set of fonts presenting the textual content of the portion of the network asset is provided from an advertisement publisher.

58. The computer readable media of claim 43, wherein receiving the one or more files representing a network asset is based on operations executed at a font service provider and an advertisement publisher.

59. The computer readable media of claim 44, wherein the set of font characters for presenting the textual content of the portion of the network asset is encoded using Base64 to reduce data transmission time.

60. The computer readable media of claim 45, the software agent includes a portion for providing static functionality and dynamic functionality.

61. The computer readable media of claim 43, wherein a portion of the network asset includes an advertisement.

62. The computer readable media of claim 45, wherein the software agent is provided to the imaging device by a font service provider, an advertisement publisher, or the one or more files representing the network asset.

63. The computer readable media of claim 43, wherein presenting the portion of the network asset on the display of the imaging device includes delaying the presentation until appropriate font characters reside at the imaging device for presenting the textual content that corresponds to the portion of the network asset.

64. The computing device-implemented method of claim 3, wherein the software agent is attainable by a static identifier for a predetermined location.

65. The system of claim 24, wherein the software agent is attainable by a static identifier for a predetermined location.

66. The computer readable media of claim 45, wherein the software agent is attainable by a static identifier for a predetermined location.
